(19) United States
(12) Patent Application Publication
(10) Pub. No.: US 2004/0063461 A1
(43) Pub. Date: Apr. 1, 2004

(54) Proactive burst contention avoidance scheduling algorithms for labelled optical burst switching networks

(76) Inventors: Jikai Li, Lockport, NY (US); Chunming Qiao, Williamsville, NY (US)

Correspondence Address: Jikai Li, c/o John Staley, 5802 Flintshire Lane, Dallas, TX, 75252, US

(21) Appl. No.: 10/672,197

(22) Filed: Sep. 26, 2003

Related U.S. Application Data
(60) Provisional application No. 60/413,732, filed on Sep. 26, 2002.

(51) Int. Cl. G06F 1/00

(52) U.S. Cl. 455/556.2; 708/109

(57) ABSTRACT

A method consisting of the application of several novel algorithms to reduce contention and loss rates at remote (downstream) nodes Labeled Optical Burst Switched (LOBS), Optical Burst Switched (OBS), Optical Packet Switched (OPS) or other networks having buffer memory at an ingress nodes and optionally having buffer memory, FDLs or other signal delay devices at intermediate (downstream) nodes. Contention and loss are reduced by delaying locally assembled bursts beyond the pre-determined offset time using the electronic memory available at the ingress nodes, or delaying transit bursts using fiber delay lines (FDLs) even though there is no contention without using FDLs at all or a smaller delay is sufficient to avoid contention at this intermediate node. Compared to existing algorithms that address contention locally (or reactively), the proposed algorithms significantly reduce the burst loss rate.

### CROSS REFERENCE TO RELATED APPLCATION

This application claims the benefit of U.S. Provisional Application No. 60/413,732, filed Sep. 26, 2002, which is incorporated by reference herein.

### FIELD OF THE INVENTION

Labeled Optical Burst Switching (LOBS) is a promising paradigm for the next-generation Internet infrastructure. In LOBS, a key problem is to schedule bursts (wherein a burst is the concatenation of one or more packets of fixed or variable lengths) on wavelength channels with both fast and bandwidth efficient algorithms so as to reduce burst loss. To date, most scheduling algorithms avoid burst contention locally (or reactively). In this invention, several novel algorithms for scheduling bursts in LOBS networks with and without Fiber Delay Lines (FDLs) or wavelength conversion capability are proposed. These algorithms pro-actively avoiding burst contention and burst loss at remote (down-stream) nodes. The basic idea is to serialize the bursts on outgoing links to reduce the burst overlapping degree (and thus burst contention and burst loss at downstream nodes). This can be accomplished by judiciously delaying locally assembled bursts beyond the pre-determined offset time using the electronic memory available at the ingress nodes, or delaying transit bursts using fiber delay lines (FDLs) even though there is no contention at this intermediate node. Compared with existing algorithms, the proposed algorithms significantly reduce the burst loss rate. The proposed methods can be applied to any network containing buffer memory at ingress nodes and optionally containing buffer memory, FDLs or other signal delay devices at intermediate or down stream nodes. In addition while the discussion focuses on bursts in LOBS networks, the term burst shall be interpreted to mean a protocol data unit (PDU), which shall be interpreted to be a packet, a frame, a burst, a wrapper, or any other protocol format for a finite quantity of data being transmitted as a group within a finite time. In a similar vein, a channel shall be interpreted to be a wavelength, an orthogonal code, a signal channel, or any other means of identifying and separating independent streams of data information traversing the network. Lastly, PDUs which are assembled at an ingress node or are passed into the network at an ingress node are said to be generated PDUs while PDUs which have already entered the network and are passing through an intermediate (or core) node are said to be transit PDUs.

### BACKGROUND OF THE INVENTION

To meet the increasing bandwidth demands and reduce costs, several optical network paradigms have been under intensive research. Of all these paradigms, optical circuit switching is relatively easy to implement but lacks flexibility to cope with the fluctuating traffic and the changing link state; Optical Packet Switching (OPS) is conceptually ideal, but the required optical technologies such as optical buffer and optical logic are too immature for it to happen anytime soon. A new approach called Optical Burst Switching (OBS) that combines the best of optical circuit switching and optical packet switching was proposed (See: M. Yoo and C. Qiao, “A high speed protocol for bursty traffic in optical networks,” SPIE's All-Optical Communication Systems: Architecture, Control and Protocol Issues, vol. 3230, pp. 79-90, November, 1997; and C. Qiao and M. Yoo, “Optical burst switching (OBS)—a new paradigm for an optical Internet,” Journal High Speed Networks, vol. 8, pp. 69-84, 1999—both herby incorporated by reference as if fully set forth herein), and has received increasing amount of attention from both academia and industry worldwide (See: Y. Xiong, M. Vandenhoute, and H. C. Cankaya, “Control architecture in optical burst-switched wdm networks,” IEEE Journal on Selected Areas in Communications, vol. 18, pp. 1838-1851, 2000; J. Turner, “Terabit burst switching,” Journal High Speed Networks, vol. 8, pp. 3-16, 1999; L. Xu, H. Perros, and G. Rouskas, “Techniques for optical packet switching and optical burst switching,” IEEE Communications Magazine, vol. 39, no.1, pp. 136-142, January 2001; A. Detti and M. Listanti, “Impact of segments aggregation on tcp reno flows in optical burst switching networks,” in IEEE Infocom 2002, pp. 1803-1812; C. Hsu, T. Liu, and N. Huang, “Performance analysis of deflection routing in optical burst-switching networks,” in IEEE Infocom 2002, pp. 66-73; all herby incorporated by reference as if fully set forth herein).

As additional references to the computational methods within this application, we site the following sources: E. McCreight, “Priority search trees,” SIAM J. Computing, vol. 14, No.2, pp. 257-276, 1985; T. H. Cormen, C. E. Leiserson, and R. L. Rivest, Introduction to Algorithms, McGraw-Hill, MIT Press, 1990; and F. Preparata and M. I. Shamos, Computational Geometry: An Introduction, Springer-Verlag, New York, 1985; all hereby incorporated by reference as if fully incorporated herein.

In a LOBS network, an ingress LOBS node assembles client data units (e.g. IP packets) into bursts and sends out a corresponding control packet for each data burst. This control packet is delivered out-of-band and leads the data burst by an offset time o. The control packet carries, among other information, the offset time at the next hop, and the burst length l. At each intermediate node along the way from ingress node to egress node, the control packet reserves necessary resources (e.g., bandwidth on a desired output channel) for the following burst, which will be disassembled at the egress node.

Using the Just-Enough-Time (JET) protocol, a control packet reserves a output wavelength channel for a period of time equal to the burst length l, starting at the expected burst arrival time r, which can be determined based on the offset time value and the amount of processing time the control packet has encountered at the node up to this point in time. If the reservation is successful, the control packet adjusts the offset time for the next hop, and is forwarded to the next hop. Otherwise, the burst is blocked and will be discarded if there is no Fiber Delay Lines (FDL). If a FDL providing d units of delay is available for use by the burst, and the channel will be available for at least l units of time starting at time r+d, the control packet will reserve both the FDL and the channel for the burst, which will not be dropped at this node.

Given the fact that LOBS uses one-way reservation protocols such as JET, and that a burst can't be buffered at any intermediate node due to the lack of optical RAM (a FDL, if available at all, can only provide a limited delay and contention resolution capability), burst loss performance is a major concern in LOBS networks. Hence, an efficient scheduling algorithm that can reduce burst loss by scheduling bursts fast and in a bandwidth efficient way is of paramount concern in LOBS network design.

### BRIEF DESCRIPTION OF PRIOR ART

So far, several scheduling algorithms have been proposed. Horizon scheduling (See: Turner 1999 of prior reference, and J. Turner, “Terabit burst switching progress report (September 1998-December 1998),” in Washington University at St. Louis Technical Report, 1998 and hereby incorporated by reference as if fully incorporated herein) does not utilize any “closed” intervals, and thus is fast but not bandwidth efficient. On the other hand, LAUC-VF (See: Xiong, Vandenhoute, and Cankaya of 2000 from prior reference above) can schedule a burst in a closed interval (i.e., as long as it is possible) but has a slow running time. Regardless the difference between LAUC-VF and Horizon, both of them schedule bursts to resolve contentions reactively (i.e. locally) instead of pro-actively to avoid possible burst contention at downstream nodes.

To avoid possible burst contention at downstream nodes, Wang (See: X. Wang, H. Morikawa and T. Aoyama, “Priority-based wavelength assignment algorithm for burst swithed photonic networks,” OFC 2002, THGG108, pp.765-767 hereby incorporated by reference as if fully incorporated herein) proposed a Priority-based Wavelength Assignment (PWA) algorithm for ingress nodes to schedule bursts. In PWA algorithm, each ingress node keeps a wavelength priority database for every destination node. When the ingress node schedules a burst, it searches the wavelength priority database, if the wavelength with highest priority is available, the burst is sent out on this wavelength, otherwise, the algorithm checks the wavelength with the second highest priority. The priority of each wavelength is updated dynamically according to its burst loss profile. Simulation shows PWA can reduce loss rate in a LOBS network. Unfortunately, PWA is only meaningful in a LOBS network without wavelength conversion capability.

In this invention, we propose novel ways to take advantage of electronic RAM, i.e. buffer memory, at ingress nodes and FDLs at intermediate nodes in LOBS or Optical Burst Switched (OBS) or Optical Packet Switched (OPS) or other networks containing buffer memory at an ingress nodes and optionally, containing FDLs, or other signal delay devices at down stream nodes, which can benefit from reduced contention and loss. The proposed algorithms try to schedule bursts (or packets) in a proactive way to avoid possible burst (or packet) loss at down stream nodes. Compared with Horizon and LAUC-VF, the proposed algorithms have a much lower loss rate. Compared with PWA, the proposed algorithms are applicable to networks with or without wavelength conversion.

### SUMMARY OF INVENTION

This invention proposes novel methods to schedule bursts in a LOBS or OBS or OPS or other network containing buffer memory at an ingress nodes and optionally, containing FDLs, or other signal delay devices at down stream nodes, so as to proactively reduce contention and loss at said downstream nodes. The following discussions assume a LOBS network and bursts for simplicity.

### BRIEF DESCRIPTION OF THE DRAWINGS

FIG. 1 depicts multiple bursts, b₁, b₂ , b₃ , and b₄ arriving at a node with some overlapping such that, if there are no FDLs at the node, then at least two bursts will have to be dropped from proceeding along the single outgoing link z.

FIG. 2 depicts the same bursts arriving at the same node as is in FIG. 1 but with burst b₂ arriving after b₁ and burst b₄ arriving after b₃ so that the overlapping of the bursts is reduced and so that no bursts will be dropped from the single outgoing link z, even if there is no FDLs at the node.

FIG. 3 depicts a LOBS network example where all packets are assembled on nodes A and B, and are disassembled on nodes C and D.

FIG. 4 depicts a pack of bursts locally generated at an Ingress Node and various results from methods scheduling that take into account the burst destinations while reduce overlapping.

FIG. 5 depicts an example data structure for a BORA-FS scheduling algorithm at an ingress node.

FIG. 6 depicts an example data structure for BORA-FS in combination with Horizon scheduling at a combined ingress & core node

FIG. 7 depicts a pack of bursts with routing information that are locally generated at an Ingress Node and various results from scheduling that take into account the routing information while reduce overlapping

FIG. 8 depicts a spanning tree rooted at node A

FIG. 9 depicts experimental results of a loss rate comparison of the new algorithm BORA-V-FS versus the prior art algorithm LAUC-VF

FIG. 10 depicts experimental results of the impact of different α values on the loss rate of the new algorithm BORA-V-FS

FIG. 11 depicts experimental results of a loss rate comparison of the new algorithm BORA-V-FS versus the new algorithm BORA-V-DS

### DETAILED DESCRIPTION OF INVENTION

In this section, we present several novel algorithms for selecting channels for incoming data bursts. Our algorithms view the scheduling problem from a global perspective of network and take advantage of electronic RAM at ingress nodes and FDLs at intermediate nodes to avoid data burst loss at downstream nodes. Before further discussion, we define overlapping degree as follows. Given a link l and time t, if there are multiple bursts arriving at link l at time t, we say these bursts are overlapped. The total number of data bursts that arrive at link l at time t is the overlapping degree, denoted as dₗ^{t}. For the period T, such as [tᵢ, tⱼ], we define the maximum overlapping degree of link l as follows,

Dₗ^{T}=max(dₗ^{t}),

where t ε T

Besides this maximum overlapping degree, sometimes we need to know the average degree of overlapping for a period. One simple way to get such value is to take several samples from this period and take an average. Fox example, if T is [tᵢ, tⱼ], we can define the average overlapping degree as follows,

$${\overline{d}}_{l}^{T} = \frac{( {d}_{l}^{{t}_{i}} + {d}_{l}^{{t}_{j}} + {d}_{l}^{\frac{{t}_{i} + {t}_{j}}{2}} )}{3}$$

In above definition, we sample three points, namely tᵢ, tⱼ and (tᵢ+tⱼ)/2.

The value of overlapping degree is directly related to the burst loss. The larger overlapping degree is, the more likely the incoming burst get dropped.

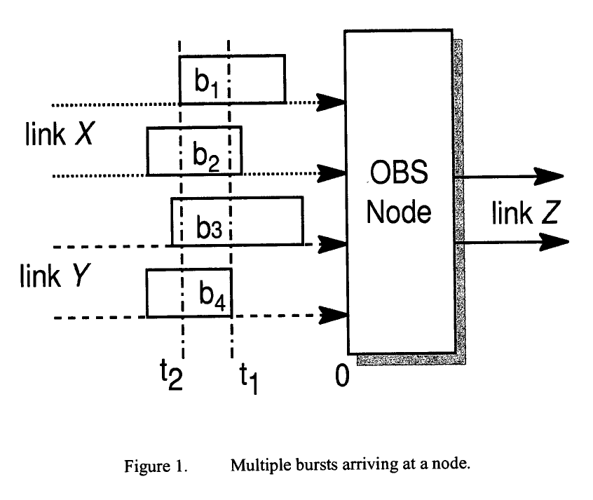

FIG. 1 shows an example where LAUC-VF fails to schedule all burst successfully. In this example, LOBS node has two incoming links and one outgoing link, each link has two wavelengths. When four data bursts, b₁, b₂, b₃ and b₄, arrive from the incoming links and these four data bursts are overlapped from time t₁ to time t₂ (in other word, d_{z} ^{(t}₁ ^{,t}₂) is 4), two out of the four bursts will be dropped if the LOBS node does not have FDL or all FDLs have already been used by other bursts.

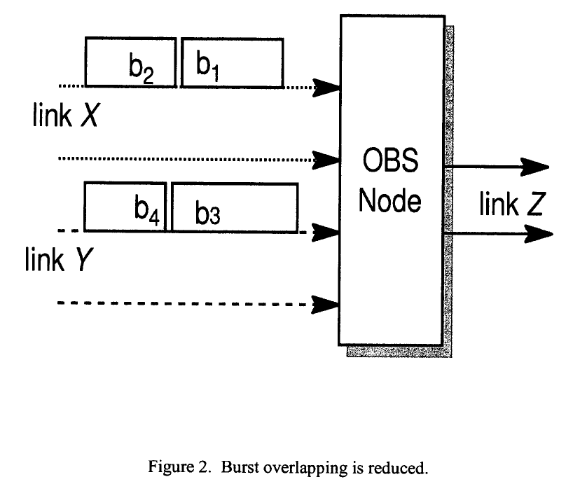

The reason of burst loss in above example is the undesired overlapping of four bursts during the period from t₁ to t₂. If we can reduce or eliminate such overlapping, the burst loss will be reduced or eliminated. In FIG. 2, burst b₂ arrives after burst b₁, and b₄ after b₃, so the overlapping of these four burst is reduced and the node will not drop any burst in this example even there is no FDLs.

Based on the above observation, we will propose several scheduling algorithms that can reduce the overlapping degree. We first discuss the LOBS networks without FDLs, then extend the work to the networks with FDLs.

Networks without FDLs or Other Intermediate Node Delay Devices

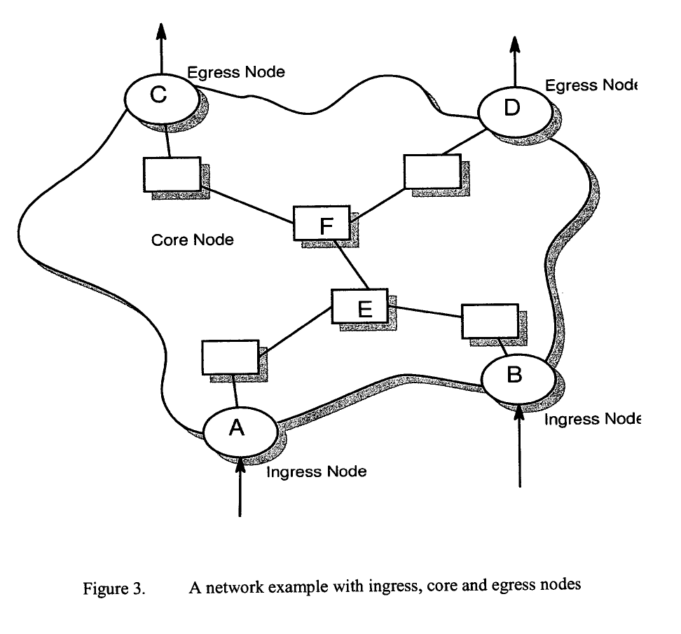

Without loss of generality, we assume there are n Labeled Optical Burst Switching (LOBS) paths (See: C. Qiao, “Labeled optical burst switching for IP-Over-WDM integration,” IEEE Communications Magazine, vol. 38, no.9, pp. 104-114, 2000 and hereby incorporated by reference as if fully incorporated herein) passing a given link l in a LOBS network. Each LOBS path has one ingress node and one egress node. In order to reduce the burst overlapping on link l, each LOBS path should try to reduce the burst overlapping of its own. In a LOBS network without FDL, the intermediate nodes can't reorder the bursts to reduce the burst overlapping, however, ingress nodes with electronic RAM can do this by using a well designed scheduling algorithm. FIG. 3 shows a network example. In this example, all packets are assembled on nodes A and B, and dissembled on nodes C and D. Suppose the burst b1 and b2 in FIG. 1 are from ingress node A, b3 and b4 from ingress node B. For node A, in order to reduce burst overlapping, it delays the sending of burst b₂ until burst b₁ is sent out. FIG. 2 shows the result of such delayed sending. Similarly, when a new burst is assembled and ready to be sent, it will be delayed, and scheduled after the tail of burst b₂. One limitation of this simple algorithm is that the delay time introduced by this algorithm could be too large. To limit the extra delaying time, we change the algorithm slightly and make it work with bounded delay time.

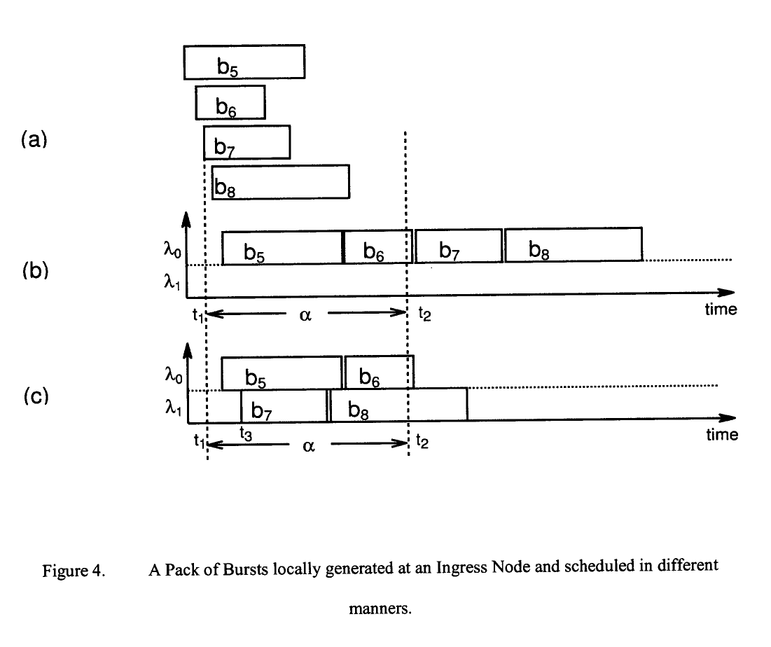

FIG. 4 shows an example how an ingress node schedule a set of locally generated bursts. FIG. 4 (a) indicates that four bursts, b₅, b₆, b₇ and b₈, arrive at scheduler, which schedules these burst sequentially. FIG. 4 (b) shows the scheduling result when ingress node ignores the delay time of each burst. In FIG. 4 (b), the delay time of burst b₇ and b₈ exceeds maximum delay time α. FIG. 4 (c) shows the scheduling result when ingress node takes delay time into consideration. After bursts b₅ and b₆ have been assigned to λ₀, ingress node tries to schedule burst b₇ to λ₀, but since the delay time of burst b₇ will be larger than the maximum delay time α, ingress node tries λ₁ as an alternate and assigns b₇ successfully. Similarly, when ingress node schedules b₈, it checks λ₀ first. Again, the delay time exceeds α, ingress node tries λ₁ and reserves the channel successfully.

Fixed Order Search

In the above description, the ingress node always searches wavelength channels using a fixed order and the algorithm stops either when a suitable channel is found which satisfies the maximum delay requirement, or all channels have been checked and none of them satisfies the requirement.

The above algorithm can work with or without utilizing the closed intervals (also called voids) that exist on each wavelength channel due to the use of JET-like reservation (See QiaoOBS1997 and QiaoOBS1999). If this algorithm schedules the locally generated (assembled) bursts using voids of each channel, we say it is Burst Overlapping Reduction Algorithm with Void filling and Fixed-ordered Searching (BORA-V-FS). If the algorithm schedules the locally generated bursts to the open interval (also called horizon) of each channel only (without void filling), we say it is Burst Overlapping Reduction Algorithm and Fixed-ordered Searching (BORA-FS).

If BORA-FS checks channels one by one, it may take time O(k) (k is the number of channel of the outgoing link) to schedule one burst. When the number of channel is hundreds or thousands, the processing time of this sequential search will be unacceptable. Below, we will describe methods to schedule the burst with time O(log k). We will introduce the data structure used by BORA-FS first, then we will extend that data structure to other situation. Our data structures are constructed by augmenting a binary search tree.

Tree Data Structured Search

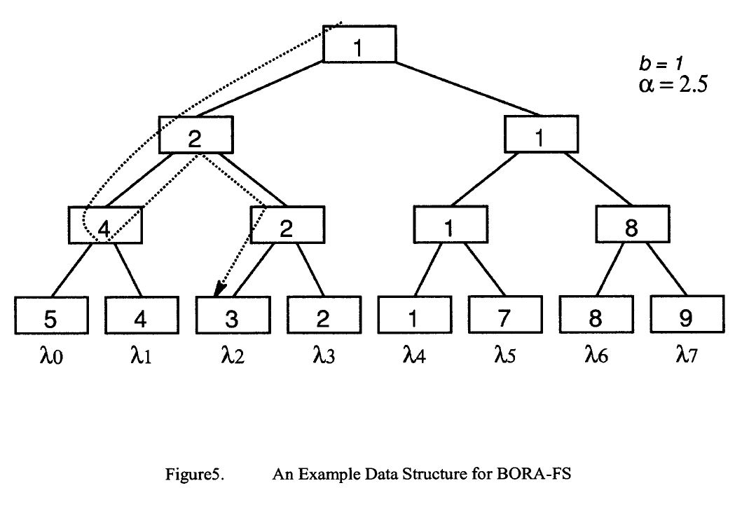

In terms of BORA-FS, we let each channel correspond to a leaf in the binary search tree. Each leaf has an entry that records the horizon starting time of the corresponding channel. Each non-leaf node has an entry records the least horizon starting value of all its children. The scheduling algorithm takes a burst b as input, and outputs the channel number and delay time if such channel exists. The scheduling algorithm starts from the root of the binary tree, if the entry value of the root is larger than r+α, that means there is no channel can accommodate this burst, otherwise, at least one channel can accommodate the burst. In this case, scheduling algorithm checks left child of the root first, if its value is larger than r+α, it then checks the right child of the root, otherwise, scheduling algorithm goes down from the left child recursively. When the channel searching stops and one channel is assigned to the burst, the starting time of that channel is updated and each node values are updated from the leaf corresponds to the assigned channel to the binary tree root. Since this tree is used to schedule locally generated bursts, we name it a generated tree. FIG. 5 shows an example where a burst arrives at time 1 and acceptable delay time is 2.5 and outgoing link has 8 wavelengths. In this example, ingress node first compares the value of the root and 3.5 (the value of r+α) and finds the former one is less than the latter one, which means at least one channel can accommodate this burst, consequentially, the ingress node then checks the value of the left child of root, and again, this value is less than 3.5, which means one of the 4 channels on the left side can accommodate this burst. Similarly, the ingress node goes down to the left child of above node and checks again, unfortunately, its value is larger than 3.5. The ingress node then goes back to the upper layer and goes down right child and check here recursively. The scheduling stops at channel 2.

In the above example, we showed how to use an augmented binary search tree to schedule the locally generated bursts at an ingress node. If a core node schedules the transit bursts with the horizon algorithm, it is straightforward to organize all horizons into a balanced binary search tree (say, red-black tree) and schedule a burst with time O(log k). To facilitate discussion, we define the transit tree to be the tree used to schedule the transit bursts.

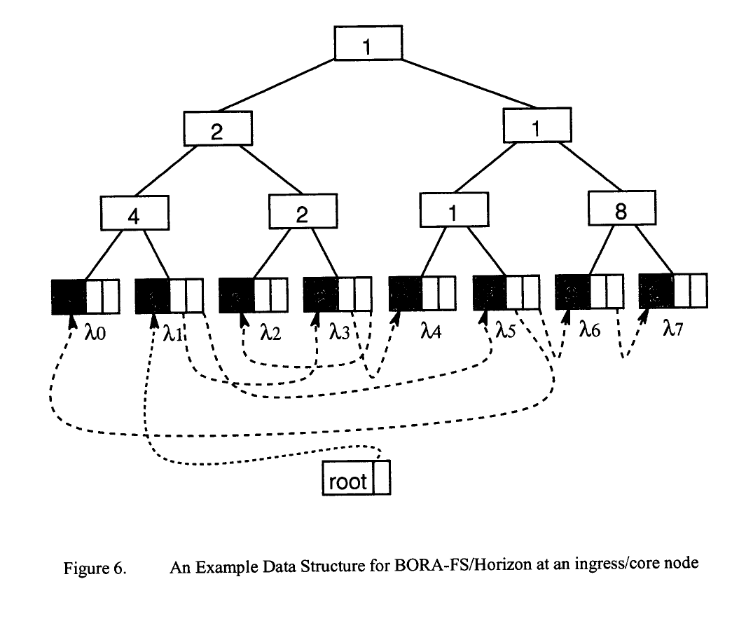

In a LOBS network, many nodes are both ingress node and core node, they have to schedule the transit bursts and the locally generated bursts at the same time. To handle transit bursts and the locally generated bursts in a fast and unified way, we can combine the generated tree and the transit tree together and modify the scheduling algorithm as follows. The generated tree is kept and a pointer field is added to each leaf. We organize the leaves into a balanced binary search tree (transit tree) through the pointers and use a root pointer to point to the root of this transit tree. When the node schedules a transit burst, it searches from the root of the transit tree. When the node schedules a locally generated burst, it searches from the root of the generated tree. In either case, the processing time is O(log k). FIG. 6 shows a data structure based on FIG. 5, the upper part of this figure is almost the same as the one in FIG. 5, the lower part is organized into a red-black tree (transit tree). When a transit burst arrives, the scheduler searches from the root of this red-black tree and stops on a leaf node if there is one channel can satisfy this burst. If the arriving burst is locally generated, scheduler searches from the root of the upper generated tree and stops at one leaf if one channel can accommodate this burst. In either situation, searching will stop in O(log k) time and tree updating will also occur in O(log k) time.

If a node which works both as an ingress node and a core node uses BORA-FS algorithm to schedule locally generated bursts and LAUC-VF to schedule the transit bursts, we can construct a data structure in a similar way. Like the data structure in FIG. 6, the data structure used by LAUC-VF and BORA-FS has two parts, the top part is a generated tree for locally generated bursts and the lower part is a transit tree for transit bursts. The top part is the same as that in FIG. 6, the leaves are the horizon of each channel, which means we assign bursts only to horizons. The lower part of the new data structure is different from that in FIG. 6. Instead of organizing horizons into a balanced binary search tree, we organize all void intervals into an augmented binary search tree described in U.S. patent application Ser. No. 10/366,890 filed Feb. 13, 2003 entitled FAST AND EFFICIENT SCHEDULING ALGORITHMS, hereby incorporated as if fully set forth herein.

The searching process of this algorithm is similar to that of FIG. 6. When a locally generated burst arrives, scheduler searches from the root of the generated tree. If a transit burst arrives, the searching begins from the root of the transit tree. In either case, the processing time is O(log m), where (m is the total number of voids).

If BORA-V-FS is used, a data structure similar to the transit tree constructed above for LAUC-VF can be used, and the worst case time complexity of this algorithm is O(m), where m is the total number of voids.

Dynamic/Destination-Based Order Search

So far, we have introduced the BORA-FS, BORA-V-FS and the fast implementations of BORA-FS for LOBS networks without FDLs. Both these two algorithms search channels in a fixed order. According to the above discussion, we can see that the fixed order channel searching reduces the overlapping degree generated by the locally generated bursts to the links that are connected to the ingress node. The idea behind this fixed order searching is that by reducing the overlapping degree of the starting link of each LOBS path, we hope the overlapping degree of each intermediate link is also reduced. Sometimes, the overlapping degree reduction does not happen automatically at the intermediate nodes. Fortunately, if we take routing information into consideration while scheduling the locally generated bursts, the overlapping degree reduction of intermediate is very likely to be reduced.

In the following, we modify the fixed-order channel searching algorithms into dynamic channel searching order algorithms that can reduce loss rate further.

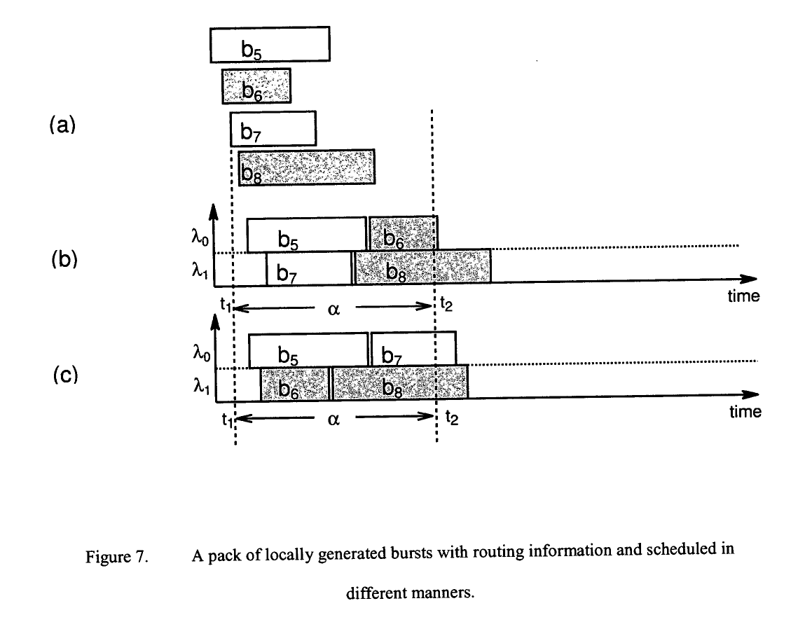

In FIG. 7 (a), four bursts arrive at a LOBS node which schedules them in the order of b₅, b₆, b₇ and b₈. FIG. 7 (b) shows the result of the fixed order channel scheduling, and overlapping degree of the outgoing link in this figure is reduced from 4 to 2. In this example, burst b₅ and b₇ take LOBS path Lᵢ, and burst b₆ and b₈ take LOBS path Lⱼ. As FIG. 7 (b) indicates, if we use a fixed order channel scheduling, bursts b₅ and b₆ are scheduled onto the same channel, burst b₇ and b₈ are assigned to another channel. For both Lᵢ and Lⱼ, the maximum overlapping degree caused by these four bursts is 2 on all links, even on the links that Lᵢ and Lⱼ do not share. This is not an ideal situation since the traffic on the unshared links is less and the overlapping degree should be smaller than that of the shared links.

If we modify the above algorithm as follows, the undesired overlapping can be removed (or mitigated). When a burst arrives, scheduler will first search the channel(s) preferred by the LOBS path it will follow (these channel(s) is called as home channel(s), the home channel(s) set is denoted by H_{I,J}, where I is the ingress node of the LOBS path and J is the egress node of the LOBS path), only if this home channel(s) can not accommodate the burst, scheduler will check other channels, otherwise, this burst will be assigned to the home channel(s). The problem of how to determine home channel(s) for each LOBS path (See: (QiaoLOBS2000) is for the most part, an orthogonal issue, and can be addressed separately.

FIG. 7 (c) shows the scheduling result of such LOBS path sensitive scheduling algorithm. When the LOBS node schedules b₆, it starts searching from λ₁(its home channel) instead of λ₀ and put the burst on λ₁, when LOBS node schedules b₇, it searches from his home channel, λ₀, and assign it there successfully. Similarly, the LOBS node assigns b₈ to λ₁, thus, the overlapping degree of Lᵢ and Lⱼ is 1 even the overall overlapping degree of the shared link is still 2. The scheduling result in FIG. 7 (c) may not reduce the loss rate on the link connected to the ingress node, but it is very likely that can reduce the loss rate on links that are not shared by Lᵢ and Lⱼ.

FIG. 7 shows an example that has only two channels and two LOBS paths. In future LOBS networks, it is likely that each network has dozens of nodes and each link has hundreds of wavelengths. In such a case, the question is how to search (and select) non-home channels when no home channels is suitable to schedule a burst? One simple approach is to search the non home channels using a fixed order (as in BORA-FS), starting at e.g., the lowest-indexed channel or the channel next to the last home channel examined. In this case, the main difference between BORA-FS and BORA-DS is that the latter searches home channels first. The basic idea of the second approach, based on traffic engineering, is as follows. To reduce the loss rate on each link, we want the overlapping of bursts from the same ingress node to be minimized thus the overlapping of overall burst over that link is minimized. Obviously, the burst overlapping of one link depends on the number of LOBS paths over it and the traffic load of each LOBS path. On the other hand, the number of LOBS paths over one link is determined by the routing algorithm adopted by the network. In the following discussion, we assume shortest path routing algorithm is applied, the ideas proposed in the following can be extended to the other routing algorithms.

For a given ingress node in a LOBS network using shortest path routing, it has a spanning tree. The burst sent out from the ingress node will pass only the edges of this spanning tree if the system does not use deflection. Therefore, the scheduling problem becomes how to minimize the burst overlapping degree of each edge of a spanning tree.

If the traffic on each LOBS path is steady, then scheduling algorithm only need to check the home channel(s). In this case, if the number of home channel(s) for all the LOBS paths passing a link is minimized, the burst overlapping of this link will likely be minimized as well. In practical situations, the traffic on each LOBS path is fluctuating instead of steady, it is possible that when a big set of burst of one LOBS path L arrives in a short period of time, all of LOBS path L's home channels(s) are occupied but other LOBS paths' home channels are available. To avoid dropping data burst at ingress node and utilize bandwidth efficiently, the ingress node can schedule the bursts to other LOBS paths' home channels. This alternative channel scheduling may adversely increase the overlapping degrees of other links. To limit this possible adverse effect, we need to take the routing information into account while selecting alternative channel.

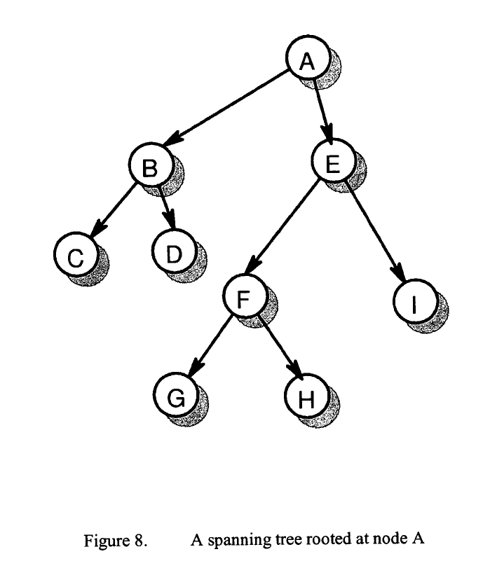

In FIG. 8, there is a spanning tree rooted at node A. When a burst destined to G arrives at node A, node A will assign it to G's home channel(s) if any possible, otherwise, node A will try node F and node H's home channels since node A, F and H share link <E,F>. The motivation that we try to assign burst to F and H's home channels is to statistically multiplex the bursts from node A to F and A to H and reduce the burst overlapping on link <E,F>. If node A can not assign the burst to these channels, it will check the home channels of node E and node I. The idea that checking home channels of E and I is that it try to reduce the burst overlapping of link <A,E>. If these channels still can not accommodate the burst, node A will check the remaining channels in a sequential order. The process will stop when there is one channel is found or when all channels has been checked and the burst gets dropped. We just gave an example that burst destination is a leaf of the spanning tree, if the burst destination is an internal node, scheduling algorithm works slightly different as follows. Suppose F is the burst destination, ingress node A first check the home channel(s) of F, if it satisfies the burst, reserve the channel, otherwise, A tries to assign the burst to the home channels of G and H. The reason we check the homes channels of G and H is that if we can statistically multiplex the bursts destined to F, G and H, the overlapping degree of link <E,F> will be reduced. If this alternative scheduling is unsuccessful, A checks the home channels of E and I. The rest is the same as the former situation.

This algorithm can be formally described as follows. Given a burst destined to node J and a spanning tree root at the ingress node, the ingress node first reserves the home channel(s) of J, if successfully, algorithm stops; otherwise, the ingress node checks the home channels that belongs to the LOBS paths from the ingress to the children nodes of J (hereafter simply referred to as the home channels of the children nodes but note each node has different home channels associated with different ingress nodes or their spanning trees). If successful, the algorithm stop, otherwise, the ingress node checks the home channels of J's parent node, and J's sibling nodes, and afterwards, the home channels of all other nodes (without having to follow any specific orders). This process continues recursively until one channel is found or all channels have been checked and the burst is dropped.

Similar to the definition of BORA-FS, if we schedule the locally generated bursts only beyond the horizon of each channel and check the channels in a sequence according to the destination of the burst, we name it as Burst Overlapping Reduction Algorithm with Destination-based Searching (BORA-DS). If we schedule the locally generated bursts using the voids of each channel (instead of only horizon), and check the channel in a sequence according to the destination of the burst, we name it as Burst Overlapping Reduction Algorithm with Void Filling and Destination-based Searching (BORA-V-DS).

Even though both BORA-DS and BORA-V-DS are more complex than BORA-FS and BORA-V-FS, fortunately, the scheduler need not compute the searching sequence every time when it schedules a burst, instead, this can be done whenever the routing table is updated and the searching sequence will be used until the next routing table update. Further more, we can use a data structure similar to the one used in FIG. 8 to implement either BORA-DS or BORAV-DS. To illustrate the procedure building such tree, we take the spanning tree in FIG. 8 as an example for BORA-DS. Without loss of generality, we assume each LOBS path is assigned with one distinctive wavelength as its home channel, the total channel number of one outgoing link is 8.

First, we copy the spanning tree in FIG. 8. Each node in the new tree corresponds to one network node and its home channel(s), it has one entry eₛ recording the horizon starting of the home channel and another entry eₗ recording the least horizon starting time of all its children. When a locally generated burst b arrives, BORA-DS first checks the eₗ of the root. If it is larger than r+α, no wavelength can accommodate b and b gets dropped, otherwise, BORA-DS starts from b's destination node. If eₛ of the destination node is less than r+α, the burst is assigned with the home channel, otherwise, BORA-DS checks eₗ of the current node, if it is larger than r+α, that means no wavelength under the node can accommodate b and BORA-DS moves to the upper layer, otherwise, at least one wavelength under current node can accommodate b and BORA-DS will do a breadth-first searching from current node. This process continues recursively until BORA-DS finds a suitable wavelength. The processing time to schedule b is within O(M), where M is the height of the spanning tree. If N is the number of nodes in a network, then we always have M≦N.

If the destination node has multiple home channels, we can enhance the tree by adding a pointer to each node. The added pointer points to a binary search tree (i.e. red-black tree). The eₛ entry of each node now records the least horizon starting time of all its home channels. The searching operation is modified correspondingly. The scheduling time of one burst is within O(M+logk).

In the above example, we showed how to use a modified spanning tree to schedule a locally generated bursts at an ingress node within time O(M+logk).

If a node in the LOBS network works as both ingress node and core node, and it uses BORA-DS algorithm to schedule locally generated bursts and uses the Horizon algorithm to schedule the transit bursts, we can construct a data structure combining above modified spanning tree with the transit tree. Like the data structure in FIG. 6, the data structure used by Horizon and BORA-DS has two parts, the top part is the modified spanning tree for locally generated burst and the lower part is the transit tree for transit burst. When a locally generated burst arrives, scheduler searches upper modified spanning tree. If a transit burst arrives, the searching begins from the root of the transit tree.

If a node in the LOBS network works as both ingress node and core node, and it uses BORA-DS algorithm to schedule locally generated bursts and uses LAUC-VF to schedule the transit bursts, we can construct a data structure similarly. The scheduling time of locally generated burst and transit burst is O(M+log k) and O(log m) respectively.

OBS Networks with FDLs

As we have shown, a LOBS network can take advantage of electronic RAM provided at ingress nodes and sequence the locally generated data bursts to reduce the loss rate of the network. We have introduced several novel algorithms to schedule the locally generated bursts at ingress nodes. In a network with FDLs, we also can take advantage of the buffering capability provided by FDLs and reorganize the transit data bursts into a better sequence at core nodes, and reduce the loss rate at downstream nodes as a result of reduced burst overlapping degree.

All recent research on FDLs, (See: QiaoOBS1999, XVC2000, Turner1999, Xu2000, Hsu20202), use FDLs only as a reactive method to resolve burst contention on a link, instead of a proactive method that can avoid any possible burst contention on the LOBS path just as what we did on ingress node scheduling.

Although FDLs can provide the buffering capability similar to that of electronic RAM, it has several limitations imposed by technical and economic reasons. First, the buffering time of one FDL is a discrete number instead of an arbitrary number of electronic RAM. The buffering time of a FDL depends on the length of FDL. Second, the FDL scheduling problem in nature is also a channel scheduling problem, it further complicates the channel scheduling problem. Since the processing time of each burst is limited, the FDL scheduling algorithm must be simple and able to process a burst quickly.

One well known FDL scheduling algorithm is described in \cite {XVC00}. It starts searching with the least available delay, and tries to use the shortest FDL to schedule the burst successfully. If scheduling is successful, it stops, otherwise, it tries to use the second shortest available FDL to schedule the burst. This process continues until either the reservation succeeds or it reaches the largest possible delay and drops the burst. We name this FDL scheduling algorithm as Smallest Delay Time Scheduling algorithm, (SDTS). The main idea of SDTS is to solve the burst contention and make the delay introduced by FDL as short as possible. On the one hand, SDTS is simple and easy to be implemented, on the other hand, it ignores the increased overlapping degree introduced by this burst and this increased overlapping degree may cause data loss in the following links.

Based on SDTS, we propose a new FDL scheduling algorithm. It first records the shortest FDL that can make the burst be accommodated by each channel. Among all these channels that can accommodate the burst, we assign the burst to the one that needs the longest FDL. We name this FDL scheduling algorithm as Burst Overlapping Reduction Algorithm with Largest Delay Time Scheduling (BORA-LDTS). The motivation that we assign the burst to the channel that needs longest FDL is that we believe this channel has more bursts than others and it is likely that some of the bursts already assigned to this channel share the same LOBS path with this incoming burst, even if the bursts on this channel do not have the same path as this incoming burst, they still have good chance to share several links with this burst. The overlapping degree caused by these sequentialized bursts is minimized over common link. As we discussed earlier, the reduced overlapping degree can reduce the burst loss. Our initial simulations have proved the effectiveness of BORA-LDTS.

Suppose the number of FDLs for one outgoing link is f, the wavelength number of each link is k, and there are i bursts try to leave the outgoing link during a short period, so that if i>(k+f), then at least (i-k-f) bursts will be dropped. Even if the algorithms designed to schedule locally generated bursts can reduce overlapping degree significantly, it is still possible that the overlapping degree of one link is larger than (k+f). On the other hand, BORA-LDTS works in a very conservative way. Normally, BORA-LDTS reserves FDLs only when there is no void that can accommodate the burst directly. During all other periods, FDLs are not utilized at all. To utilize FDLs efficiently and to reduce overlapping degree, we design a new algorithm based on BORA-LDTS or its variants, the new algorithm utilizes FDLs to reduce the overlapping degree even when there is no burst contention. Without loss of generality, we use BORA-LDTS to illustrate our idea.

For each incoming link, we have a non-negative integer Threshᵢ. For each outgoing link, we have another non-negative integer Threshₒ. When the core node notices that average overlapping degree of one outgoing link is larger than Threshₒ, the core node use BORA-LDTS algorithm (or its variants) to schedule bursts in order to sequentialize bursts and reduce the overlapping degree. If the average overlapping degree of one outgoing link is less than Threshₒ, the core node uses an algorithm (such as LAUC-VF) that schedules bursts without using FDLs. Similarly, when the core node notices that average overlapping degree of one incoming link is larger than Threshᵢ, it send an notification message to upstream node. Upon receiving the message, the upstream node uses BORA-LDTS algorithm (or its variants) to schedule bursts and try to reduce the overlapping degree of its outgoing link (as the upstream node is the incoming link of the downstream node).

By using FDLs to pro-actively avoid burst contention as described above, the overlapping degree and thus burst contention and burst loss can be reduced.

Experimental Results

This section presents our experimental results of our searching algorithm and its comparison with existing algorithm LAUC-VF. Our experiments focus on examining the loss rate of these algorithms. The network topology used in this simulation is the 14-node NSFNET. Our simulations observe the loss rate of whole network. We assume that both burst length and control packet inter-arrival time follow the Pareto distribution, and the offset time is determined by JET. The number of channels on each link is 13 and the bandwidth of each wavelength is 10 Gbps and the average burst duration is 0.1 ms. In our simulation, we assume each node is both a ingress node and a core node, each node has a evenly loaded LOBS path to all other nodes. The LOBS paths used in our simulation is computed by shortest path algorithm.

LAUC-VF vs. BORA-V-FS

To compare our BORA-V-FS algorithm with LAUC-VF, we use these two algorithms to schedule locally generated bursts and compare the loss rate of these two algorithms. We conduct two simulations, one investigates the relationship between load and loss rate, one studies the relationship between α value and loss rate. In both simulations, we use LAUC-VF to schedule the transit bursts.

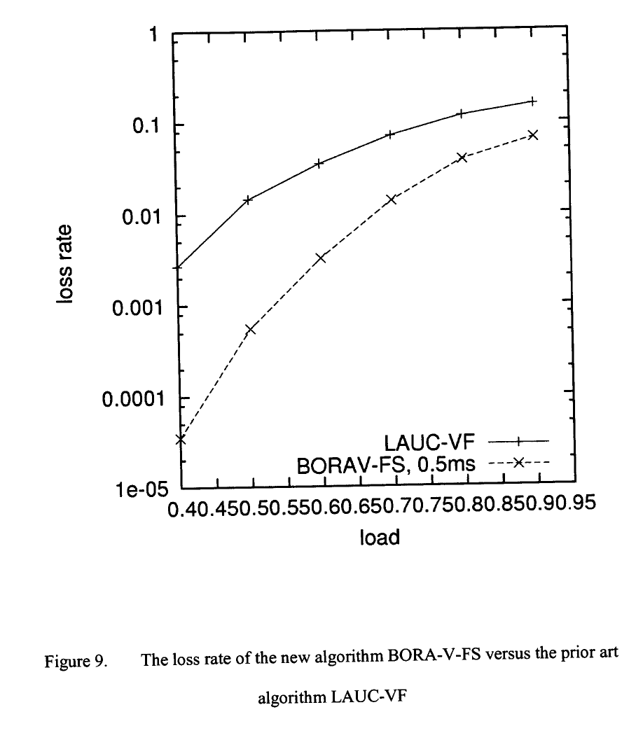

FIG. 9 shows the loss rate of LAUC-VF algorithm and BORA-V-FS algorithm when α is 0.5 ms. We can see loss rate of BORA-V-FS is much lower than the LAUC-VF, especially traffic load is low and medium, the loss rate of new algorithm is about 100 times lower than that of the LAUC-VF. When the network is heavily loaded, the system becomes sensitive to the variation of load and some lines can be easily overloaded when the load fluctuates. In this situation, the effect of BORA-V-FS is mitigated. Even in this heavily loaded network, the loss rate of our BORA-V-FS algorithm is still several times lower than LAUC-VF.

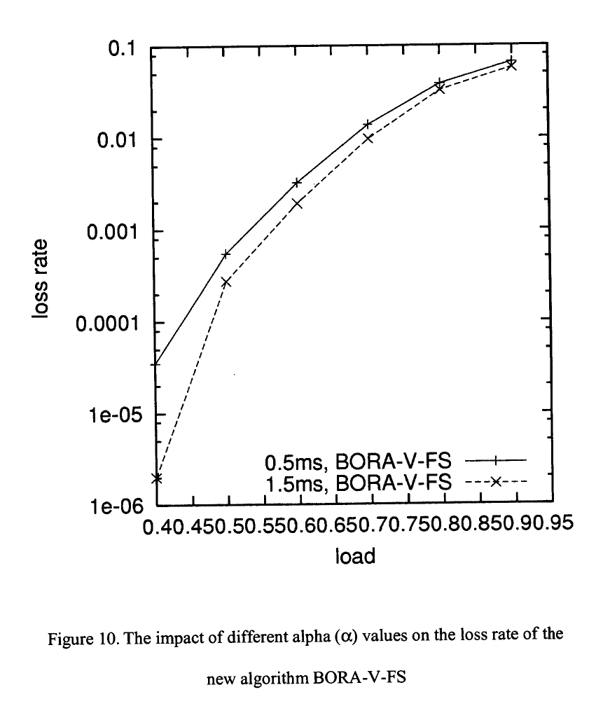

Different a values have different effects on the loss rate. FIG. 10 shows the loss rate of BORA-V-FS algorithm when α is 1.5 ms and 0.5 ms. In this figure, we observe that the performance of 1.5 ms is better than that of 0.5 ms. The reason is that the larger α has a more significantly smoothing effect, which reduces the burst overlapping degree.

BORA-V-FS vs. BORA-V-DS

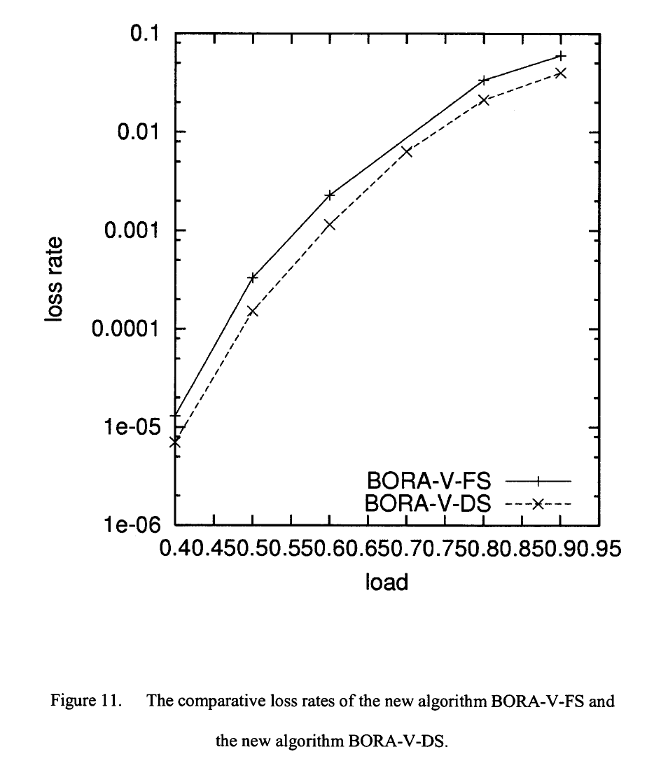

For BORA-V-FS and BORA-V-DS, we conduct another simulation. In this simulation, we use LAUC-VF to schedule the transit bursts, but use BORA-V-FS and BORA-V-DS to schedule locally generated bursts respectively. α is 1.0 ms in this simulation. FIG 11 shows the loss rate of BORA-V-FS and BORA-V-DS. It clearly indicates that BORA-V-DS has better performance under any traffic load.

### CONCLUSION

This invention proposes several novel channel scheduling algorithms for reducing contention and loss in LOBS, OBS, OPS or other networks having buffer memory at an ingress nodes and optionally having buffer memory, FDLs or other signal delay devices at intermediate (downstream) nodes. Unlike all the existing algorithms, the proposed BORA family of algorithms tries to reduce burst overlapping at the output links, and thus burst contention and burst loss at down stream nodes.

Although the present invention and its advantages have been described in the foregoing detailed description and illustrated in the accompanying drawings, it will be understood by those skilled in the art that the invention is not limited to the embodiment(s) disclosed but is capable of numerous rearrangements, substitutions and modifications without departing from the spirit and scope of the invention as defined by the appended claims.

What is claimed is:

1. A method for reducing contention and loss probabilities for PDUs arriving at downstream nodes comprising the steps of:
delaying the sending a PDU generated at an ingress node beyond said PDU's pre-determined minimum offset time, or zero delay, for a maximum delay time,
optionally, delaying a PDU in transit at an intermediate node, even though there is no contention at said intermediate node without using said delay, or when a smaller delay at said intermediate node is sufficient to avoid contention at said intermediate node.

2. A method of claim 1 wherein PDU's assembled or entering the network at an ingress node are scheduled independently of the method of delay used at intermediate nodes comprising the steps of:
determining a maximum delay requirement,
performing a search among channels for an interval on a channel that satisfies the maximum delay requirement,
scheduling the PDU into the interval identified on the identified channel and updating the interval information for said identified channel,
dropping the PDU if no channel is identified as having an interval satisfying the maximum delay requirement.

3. A method of claim 1 wherein PDU's assembled or entering the network at an ingress node are scheduled comprising the steps of:
determining a maximum delay requirement,
performing a sequential search in a fixed order among channels for an interval on a channel that satisfies the maximum delay requirement,
scheduling the PDU into the first search channel identified as having a satisfying interval, and updating the interval information for said identified channel,
dropping the PDU if no channel is identified as having an interval satisfying the maximum delay requirement.

4. A method of claim 1 wherein the scheduling of PDU's assembled or entering the network at an ingress node comprises the steps of:
determining a maximum delay requirement,
performing a search among a few selected channels called the home channels corresponding to the egress node using any order (sequential, random) for an interval on a home channel that satisfies the maximum delay requirement,
scheduling the PDU into the first such home channel identified as having a satisfying interval, and updating the interval information for said identified channel,
performing a sequential search in a fixed order among the rest, non home channels for an interval on a non home channel that satisfies the maximum delay requirement,
scheduling the PDU into the first non home channel identified as having a satisfying interval, and updating the interval information for said identified channel,
dropping the PDU if no channel is identified as having an interval satisfying the maximum delay requirement.

5. A method of claim 1 wherein the scheduling of PDU's assembled or entering the network at an ingress node comprises the steps of:
determining a maximum delay requirement,
performing a search among a few selected channels called the home channels corresponding to the egress node using any order (sequential, random) for an interval on a home channel that satisfies the maximum delay requirement,
scheduling the PDU into the first such home channel identified as having a satisfying interval, and updating the interval information for said identified channel,
performing a search among the non home channels of the said egress node for an interval on a channel that satisfies the maximum delay requirement, with the highest preference given to the home channels corresponding to the immediate downstream nodes called the children nodes of the said egress node, with respect to a spanning tree rooted at the said ingress node and specifying the paths to each and every other egress node, the second highest preference given to the home channels corresponding to the immediate upstream nodes called the parent nodes of the said egress node, with respect to the said spanning tree rooted at the said ingress node and specifying the paths to each and every other egress node, and the third highest preference given to the home channels corresponding to the rest of the nodes using any order (sequential, random), and the lowest preference to all other channels,
scheduling the PDU into the first channel identified as having a satisfying interval, and updating the interval information for said identified channel,
dropping the PDU if no channel is identified as having an interval satisfying the maximum delay requirement.

6. A method of claim 1 wherein PDU's assembled or entering the network at an ingress node are scheduled comprising the steps of:
determining a maximum delay requirement
constructing a binary search tree where every leaf node records its associated channel's horizon starting time and each non-leaf node records the least horizon starting value of all of its child nodes
searching this binary tree until a first channel is identified containing an interval that satisfies the maximum delay requirement,
scheduling the PDU onto the interval identified on the identified channel and updating the binary search tree data structure,
dropping the PDU if no channel is identified as satisfying the maximum delay requirement.

7. A method of claim 1 wherein the scheduling of PDUs assembled or entering the network at a node performing as an ingress node, or the scheduling of PDUs transiting this same node performing as an intermediate node, comprising the steps of:
determining a maximum generated PDU and transit PDU delay requirements
constructing a balanced binary search tree consisting of a generated tree for locally generated PDUs where every leaf node records its associated channel's horizon starting time and each non-leaf node records the least horizon starting value of all of its child nodes, and which is then augmented wherein a pointer field is added to each generated tree leaf and these pointers are then organized into a transit tree with a root pointer point to the root of this transit tree,
in the case of generated PDUs, then searching this balanced tree from the root of the generated tree until an interval and channel satisfying the generated maximum delay requirement is identified,
in the case of transit PDUs, then searching this balanced tree from the root of the transit tree until an interval and channel satisfying the transit maximum delay requirement is identified,
scheduling the PDU onto the interval identified on the identified channel and updating the balanced binary search tree data structure,
dropping the PDU if no channel is identified as satisfying the PDU's associated maximum delay requirement

8. A method of claim 1 wherein the scheduling of PDUs assembled or entering the network at a node performing as an ingress node, or the scheduling of PDUs transiting this same node performing as an intermediate node, comprising the steps of:
determining a maximum generated PDU and transit PDU delay requirements
constructing a search data structure for generated and transit PDUs based upon the methods of U.S. patent application Ser. No. 10/366,890 without FDLs
searching this data structure per the methods of 10/366,890 until an interval and channel satisfying the PDUs associated maximum delay requirement is identified,
scheduling the PDU onto the interval identified on the identified channel and updating the data structure,
dropping the PDU if no channel is identified as satisfying the PDU's associated maximum delay requirement

9. A method of claim 1 wherein the scheduling of PDUs assembled or entering the network at a node performing as an ingress node, or the scheduling of PDUs transiting this same node performing as an intermediate node, comprising the steps of:
determining a maximum generated PDU and transit PDU delay requirements
constructing a search data structure for generated PDUs based upon the methods of U.S. patent application Ser. No. 10/366,890 without FDLs, and for transit PDUs, based upon the methods of U.S. patent application Ser. No. 10/366,890 with FDLs,
searching this data structure per the methods of 10/366,890 until an interval and channel satisfying the PDUs associated maximum delay requirement is identified,
scheduling the PDU onto the interval identified on the identified channel and updating the data structure,
dropping the PDU if no channel is identified as satisfying the PDU's associated maximum delay requirement

10. (BORA-V-FS) A method of claim 1 wherein the scheduling of PDU's assembled or entering the network at an ingress node comprising the steps of:
determining a maximum delay requirement
constructing a binary search tree where every leaf node records its associated channel's horizon starting time and each non-leaf node records the least horizon starting value of all of its child nodes,
searching this binary tree until a first channel is identified that satisfies the maximum delay requirement,
scheduling the PDU onto an the identified interval on the identified channel
dropping the PDU is no channel is identified as satisfying the maximum delay requirement
